(19) United States
(12) Patent Application Publication
(10) Pub. No.: US 2026/0176009 A1
(43) Pub. Date: Jun. 25, 2026

(54) CASERS FOR PRODUCT CONTAINERS

(71) Applicant: Dairy Conveyor Corp., Brewster, NY (US)

(72) Inventors: Phillip Levine, Rosemount, MN (US); Douglas Levine, Inver Grove Heights, MN (US)

(73) Assignee: Dairy Conveyor Corp., Brewster, NY (US)

(21) Appl. No.: 18/988,482

(22) Filed: Dec. 19, 2024

(51) Int. Cl. B65B 5/06; B65G 47/24; B65G 47/82

(52) U.S. Cl. CPC B65B 5/06; B65G 47/24; B65G 47/82; B65G 2201/0235

(57) ABSTRACT

A caser for packaging a product container in a case includes an infeed conveyor configured to receive the product container at an upstream first conveyor end and convey the product container downstream to a second conveyor end from which the product container is dispensed, the infeed conveyor has a first orientation at a first conveyor end and a second orientation at a second conveyor end, wherein the orientation of the infeed conveyor transitions from the first orientation to the second orientation from the first conveyor end to the second conveyor end such that the infeed conveyor is configured to change orientation of the product container as the product container is conveyed by the infeed conveyor, and a casing station configured to receive the product container from the infeed conveyor and dispense the product container into the case.

### FIELD

The present disclosure relates to systems, apparatuses, and methods for loading product containers into cases.

### BACKGROUND

The following U.S. Patent Application Publication is incorporated herein by reference in entirety.

U.S. Patent Application Publication No. US2012/0175221 discloses an apparatus for selectively diverting same size articles including a conveying apparatus, a pusher device positioned proximal the conveying apparatus, at least one divergent pathway disposed transverse to the conveying apparatus and substantially opposite the pusher device, and at least one sensor positioned proximal the pusher device, wherein the sensor is operable to detect the presence or absence of an article on the conveyor apparatus and actuate the pusher device to selectively push the article to the divergent pathway. A velocity control device operates to control the flow of articles along the conveying device.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a caser for packaging a product container in a case includes an infeed conveyor configured to receive the product container at an upstream first conveyor end and convey the product container downstream to a second conveyor end from which the product container is dispensed, the infeed conveyor has a first orientation at a first conveyor end and a second orientation at a second conveyor end, wherein the orientation of the infeed conveyor transitions from the first orientation to the second orientation from the first conveyor end to the second conveyor end such that the infeed conveyor is configured to change orientation of the product container as the product container is conveyed by the infeed conveyor, and a casing station configured to receive the product container from the infeed conveyor and dispense the product container into the case.

Optionally, the infeed conveyor is a continuous belt. Optionally, the first orientation is a horizontal orientation and the second orientation is a diagonal orientation. Optionally, the infeed conveyor is configured to minimize and backpressure acting on the product container and distribute backpressure to additional product containers conveyed by the infeed conveyor. Optionally, the second orientation is 60.0 degrees offset from the first orientation. Optionally, the infeed conveyor is a first infeed conveyor and a second infeed conveyor cooperates with the first infeed conveyor to convey the product containers from the first conveyor end to the second conveyor end and the second infeed conveyor has a first orientation at a first conveyor end and the orientation of the second infeed conveyor transitions from the first orientation to a second orientation at a second conveyor end of the second infeed conveyor such that the second infeed conveyor is configured to cooperate with the first infeed conveyor to thereby change the orientation of the product container. Optionally, the first infeed conveyor and the second infeed conveyor cradle the product container. Optionally, the first infeed conveyor and the second infeed conveyor are continuous belts. Optionally, the first infeed conveyor and the second infeed conveyor extend perpendicular to each other. Optionally, the first orientation of the first infeed conveyor is horizontal orientation and the first orientation of the first infeed conveyor is vertical. Optionally, the second orientation of the first infeed conveyor is a first diagonal orientation and the second orientation of the second infeed conveyor is a second diagonal orientation, and the first diagonal orientation is perpendicular to the second diagonal orientation. Optionally, the infeed conveyor includes a guide member that supports the infeed conveyor, and the orientation of the guide member corresponds to the orientation of the infeed conveyor. Optionally, the infeed conveyor includes a plurality of brackets that support the guide member and the infeed conveyor. Optionally, each bracket has a first leg and a second leg, and the orientation of the first leg and the second leg of one bracket in the plurality of brackets is different than the orientation of the first leg and the second leg of another bracket in the plurality of brackets. Optionally, the casing station configured to receive the case, and the casing station includes a first support member onto which the product container is conveyed and a pusher configured to push the product container into the case. Optionally, the casing station includes a servo motor for moving the pusher. Optionally, the pusher is movable into and between a first position in which the pusher is located above the product container and a second position in which the pusher pushes the product container into the case and when the pusher is moved away from the second position toward the first position, the pusher is first moved in a second pusher direction past the first position before being moved in a first pusher direction back to the first position.

In certain examples, a caser for packaging a product container in a case includes an infeed conveyor system with a first system end configured to receive the product container and a second system end configured to dispense the product container, the infeed conveyor system has a first infeed conveyor configured to support the product container at the first system end and convey the product container downstream toward the second system end and a second infeed conveyor configured to support the product container such that the product container is cradled between the second infeed conveyor and the first infeed conveyor and convey the product container downstream toward the second system end, and a casing station configured to receive the product container from the infeed conveyor system and load the product container into the case.

Optionally, the first infeed conveyor has a first orientation at the first system end and the orientation of the first infeed conveyor transitions from the first orientation to a second orientation in a direction toward the second system end such that that first infeed conveyor is configured to change orientation of the product container and the second infeed conveyor has a first orientation at the first system end and the orientation of the second infeed conveyor transitions from the first orientation to a second orientation in a direction toward the second system end. Optionally, the infeed conveyor is a continuous belt. Optionally, the first orientation of the first infeed conveyor is a horizontal orientation, the first orientation of the second infeed conveyor is a vertical orientation, the second orientation of the first infeed conveyor is a diagonal orientation, and the second orientation of the second infeed conveyor is a diagonal orientation.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example caser according to the present disclosure.

FIG. 2 is another perspective view of the caser of FIG. 1.

FIG. 3 is a perspective view of a first system end of an example infeed conveyor system according to the present disclosure.

FIG. 4 is a perspective view of a second system end of the example infeed conveyor system.

FIG. 5 is a perspective view of an example frame according to the present disclosure.

FIG. 6 is a top-down plan view of the frame.

FIG. 7 is a side view of an example bracket according to the present disclosure.

FIG. 8 is a side view of another example bracket according to the present disclosure.

FIG. 9 is a cross-sectional view of the frame along line 9-9 on FIG. 5.

FIG. 10 is a cross-sectional view of the frame along line 10-10 on FIG. 5.

FIGS. 11-18 are schematic views depicting an example operational sequence according to the present disclosure.

FIGS. 19-22 are perspective views of an example casing station related to the operational sequence depicted in FIGS. 11-18.

FIG. 23 is an example control system according to the present disclosure.

FIG. 24 is an example method according to the present disclosure.

### DETAILED DESCRIPTION

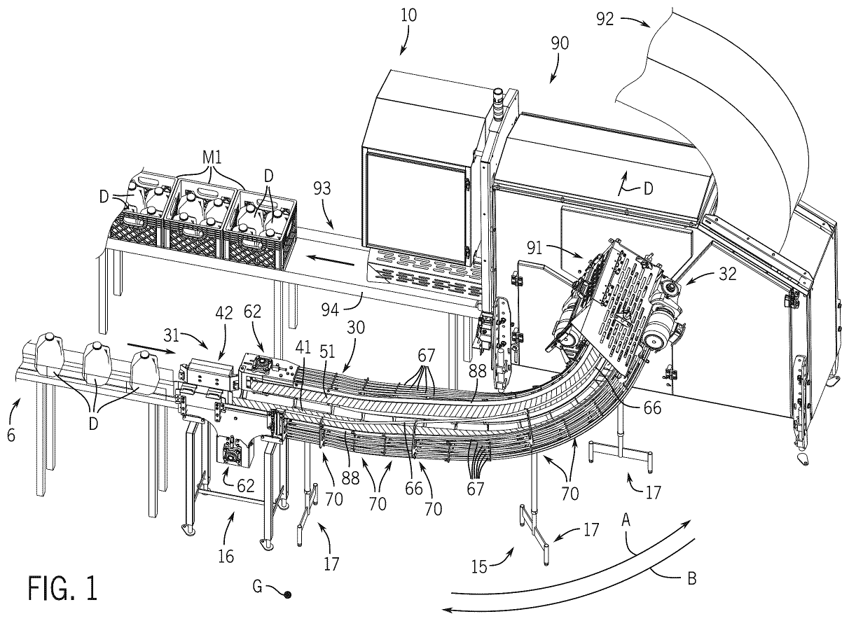

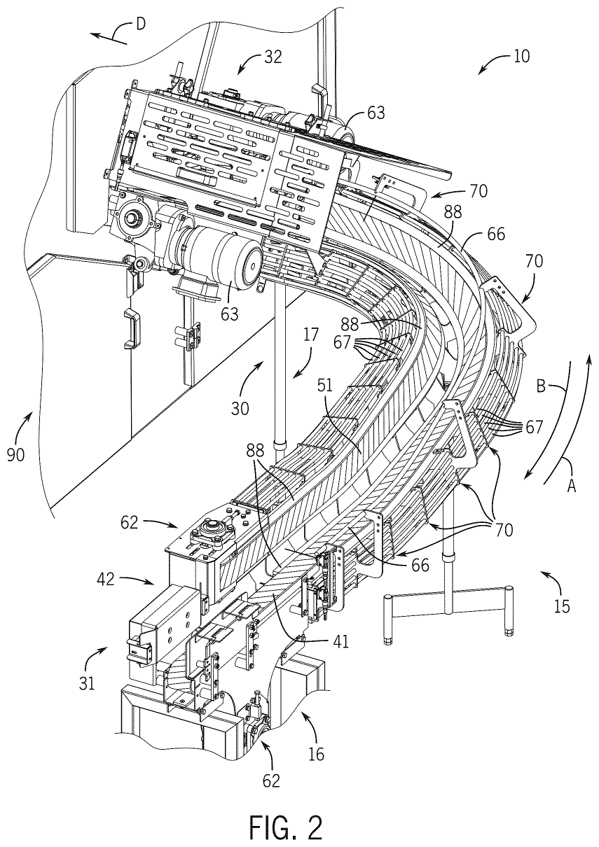

FIGS. 1-2 depicts an example caser 10 according to the present disclosure. The caser 10 is configured to receive product containers containing consumable products, such as plastic gallon or half-gallon dairy containers containing milk. The caser 10 includes an infeed conveyor system 30 that directs dairy containers D to a casing station 90 (described further herein) that loads the dairy containers D into milk crates M. The caser 10 dispenses milk crates M loaded with dairy containers D. The caser 10 is configured to properly orientate the dairy containers D for loading into the milk crates M. Note that while the example casers 10 of the present disclosure described herein refers to the product containers as dairy products D, such as plastic gallon or half gallon milk jugs, the caser 10 can be utilized to process other types of product containers and products such as fruit juice containers, metal jugs, ceramic jugs, or the like. Also note that while the example casers 10 of the present disclosure described herein refers to the cases as milk crates M, the caser 10 can load the product containers in other cases such as cardboard boxes, plastic boxes, wood boxes, wood crates, and/or the like.

The infeed conveyor system 30 includes an upstream first system end 31 that is configured to receive dairy containers D from an upstream conveyor system 6. The upstream conveyor system 6 may be an existing conveyor or other system in the facility such as a bottler system or labeling system.

The infeed conveyor system 30 also includes a downstream second system end 32 that is coupled to and/or adjacent to the casing station 90 such that the infeed conveyor system 30 dispenses the dairy containers D from the second system end 32 to the casing station 90 for loading into the milk crates M.

The present inventors observed that conventional systems that direct dairy containers to conventional casing stations often utilize a belt that conveys the dairy containers forcefully into stationary rails to induce a change in orientation of the dairy containers e.g., the stationary rails cause the dairy containers to move from a vertical orientation into an angled orientation. Forcing the dairy containers into the stationary rails causes the dairy containers to buckle and flex and potentially break or leak. The reorientated dairy containers are dispensed into the conventional casing station and loaded into milk crates. The present inventors also observed that as the dairy containers are forced into the stationary rails a large number of dairy containers on the conventional conveyor are subjected to a large amount of upstream back pressure. The present inventors recognized that the diary container may damage and/or begin to leak under the forces induced on the dairy containers as the dairy containers contact the stationary rails and/or the backpressure acting on the dairy containers. The damaged and/or leaking diary containers may cause jams in the conventional caser and/or damage components of the conventional caser.

As such, through research and experimentation, the present inventors endeavored to develop the example casers 10 of the present disclosure that reduce or eliminate forces that may cause damage to the dairy containers D and thereby reduce or eliminate jams and/or damage of the casers 10. The present inventors also recognized that the example casers 10 of the present disclosure advantageously removes the need for belted accelerators of conventional systems that are a secondary driven belt system for contacting the sides of the dairy containers to assist in driving the dairy containers through fixed rails. By not requiring the belted accelerators, the casers 10 of the present disclosure are less complex and avoid problems associated with the accelerators rubbing on the dairy containers especially when the dairy containers are in the conventional systems.

A pair of infeed conveyors, namely a first infeed conveyor 41 and a second infeed conveyor 51, extend between the system ends 31, 32 and are configured to individually or collectively convey the dairy containers D from the first system end 31 to the second system end 32. The infeed conveyors 41, 51 can be any suitable device that is for conveying the dairy containers such as a belt, chain links, a fabric strap, a metal drive belt, and/or the like. In the example depicted in FIGS. 1-2, the infeed conveyors 41, 51 are continuous belts formed with plastic, rubber, silicone, and/or metal materials. The infeed conveyors 41, 51 are supported by a frame 15 (described further herein). Each of the infeed conveyors 41, 51 are described in greater detail herein below with reference to FIGS. 1-4.

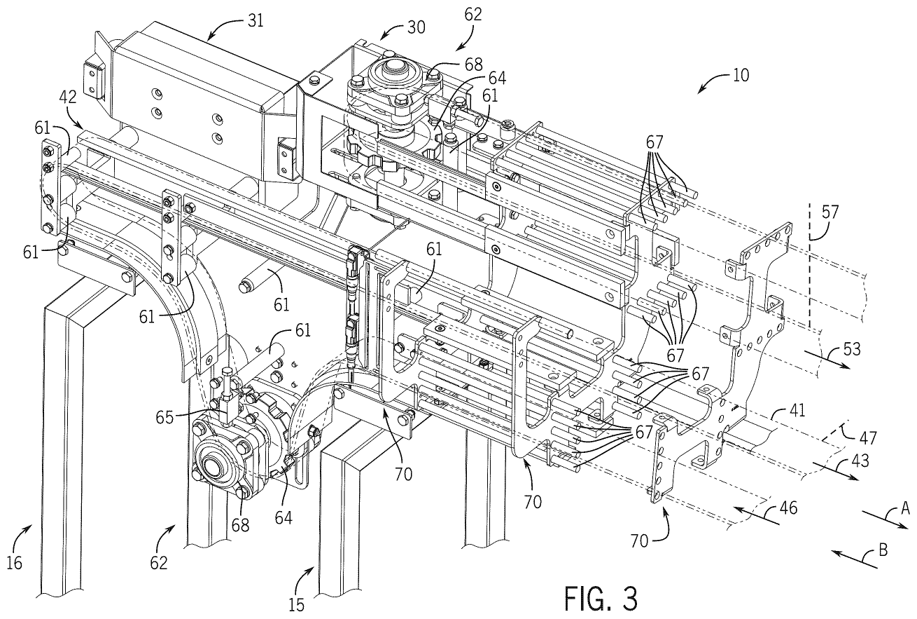

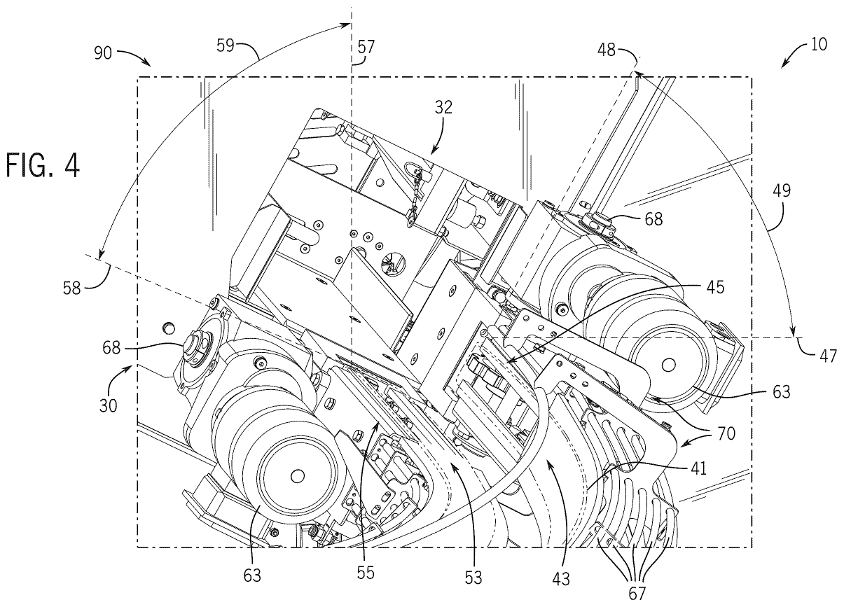

The first infeed conveyor 41 is exemplarily a continuous belt that extends along the frame 15. The frame 15 can include a plurality of brackets 70, one or more spacers 61 of sprocket, and/or one or more guide members 88. The first infeed conveyor 41 is driven by one or more drive assemblies 62 along the frame 15. Each drive assembly 62 can include any suitable component(s) as a drive 63 (e.g., motor), idlers 65, a chain tensioner 68, and one or more sprockets 64. The first infeed conveyor 41 extends around the sprockets 64. The sprockets 64 are mounted on slots in order to tension the chain and remove slack from the first infeed conveyor 41. The sprockets 64 can accommodate tabbed conveyors. In the example depicted in FIGS. 3-4, one drive assembly 62 for the first infeed conveyor 41 is located at the first system end 31 and another drive assembly 62 is located at the second system end 32. The drive assemblies 62 cooperate to drive the first infeed conveyor 41 in a loop through the infeed conveyor system 30.

Referring specifically to FIGS. 3-4, the first infeed conveyor 41 (depicted in dash-dot lines) extends along the drive assembly 62 at the first system end 31 and has a first conveyor end 42 at a first end of a travel path 43 along which the dairy containers D is generally a first direction (arrow A in FIG. 1) from the first system end 31 to the second system end 32. Note that the travel path 43 and/or the first direction (arrow A) extend along the shape defined by the frame 15. The first infeed conveyor 41 extends along the travel path 43 to a second conveyor end 45 that is at or near the second system end 32 such that the dairy containers D are dispensed to the casing station 90. The first infeed conveyor 41 then transitions from the travel path 43 to a return path 46 (see FIG. 3) that extends from the second system end 32 to the first system end 31. The return path 46 generally extends in a second direction (arrow B) and the return path 46 and the second direction is defined by the frame 15. The first infeed conveyor 41 then transitions from the return path 46 back to the travel path 43 at the first system end 31. The first infeed conveyor 41 is continuously driven along the travel path 43 and the return path 46 to thereby convey the dairy containers D to the casing station 90.

The first infeed conveyor 41 is supported by guide members 88 (e.g., panel, bar), and the guide members 88 located at the first system end 31 vertically support the first infeed conveyor 41 and the dairy containers D thereon. The brackets 70 hold the guide members 88 in place such that the first infeed conveyor 41 passes along and/or over the guide members 88. Note that several guide members 88 are excluded from FIGS. 3-4 and the brackets 70 for clarity. The guide members 88 can be formed of any suitable material such as plastic. In certain examples, the guide members 88 are formed with anti-friction materials that reduce or eliminate friction between the guide members 88 and the first infeed conveyor 41.

The first infeed conveyor 41 at the first conveyor end 42 is in a first orientation (e.g., horizontal orientation), and the orientation of the first infeed conveyor 41 transitions to a second orientation (e.g., diagonal orientation) as the first infeed conveyor 41 is conveyed along the travel path 43. For example, the first infeed conveyor 41 transitions from the first orientation to the second orientation between the first conveyor end 42 and the second conveyor end 45 such that the first infeed conveyor 41 at the second conveyor end 45 is in a second orientation.

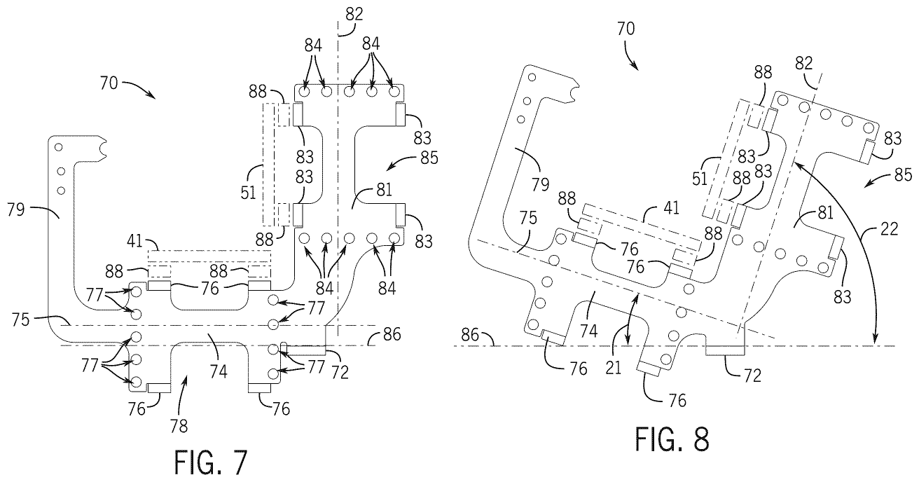

For illustrative purposes, FIG. 3 includes a first reference axis 47 that extends parallel with the plane of the top surface of the first infeed conveyor 41 at the first conveyor end 42 and illustrates the first orientation of the first infeed conveyor 41 at the first conveyor end 42. FIG. 4 includes a second reference axis 48 that extends parallel with the plane of the top surface of the first infeed conveyor 41 at the second conveyor end 45 and illustrates the second orientation of the first infeed conveyor 41 at the first conveyor end 42. FIG. 4 also includes the first reference axis 47 for comparison. In FIG. 7, the reference axes 47, 48 define an angle 49 therebetween that corresponds to the degrees the first infeed conveyor 41 is reoriented from the first conveyor end 42 to the second conveyor end 45. In certain examples, the angle 49 is in the range of 0.0 degrees to 60.0 degrees. In other examples, the angle 49 is in the range of 0.0 degrees to 90.0 degrees. Note that the example ranges noted herein are inclusive of the end values of the ranges. The shape of the first infeed conveyor 41 can be customized to convey the dairy containers (as well as in other example other products) by placing the brackets 70 in specific locations.

The change of the first infeed conveyor 41 from the first orientation to the second orientation may be incremental or continuous along the travel path 43. As the orientation of the first infeed conveyor 41 changes (as noted above), the orientation of the dairy containers D on the first infeed conveyor 41 also changes. For example, the dairy containers D on the first infeed conveyor 41 at the first conveyor end 42 are oriented in a first container orientation (e.g., vertical orientation, orientation perpendicular to the first orientation of the first infeed conveyor 41 at the first conveyor end 42) and the dairy containers D on the first infeed conveyor 41 at the second conveyor end 45 are in a second container orientation in which the dairy containers D are in the proper orientation for processing by the casing station 90 (described further herein). In certain examples, the bottom of the dairy container D engages with the first infeed conveyor 41. In one example, the second container orientation is perpendicular to the second orientation of the first infeed conveyor 41 at the second conveyor end 45. In another example, the second container orientation is a diagonal orientation that is between a horizontal orientation and a vertical orientation. For instance, a diagonal orientation may be 60.0 degrees offset relative to a horizontal orientation such that the dairy containers D are ‘laid’ down on the side wall. Note that the guide members 88 that extend along and support the first infeed conveyor 41 also change orientation to match the orientation of the first infeed conveyor 41.

The second infeed conveyor 51 is for cooperating with the first infeed conveyor 41 to convey the dairy containers D to the casing station 90. The second infeed conveyor 51 is exemplarily a continuous belt that extends along the frame 15. The first infeed conveyor 41 is driven by one or more drive assemblies 62 around and/or through the frame 15. In the example depicted in FIGS. 3-4, one drive assembly 62 for the second infeed conveyor 51 is located at the first system end 31 and another drive assembly 62 is located at the second system end 32. The drive assemblies 62 cooperate to drive the second infeed conveyor 51 in a loop through the infeed conveyor system 30.

Referring specifically to FIGS. 3-4, the second infeed conveyor 51 (depicted in dash-dot lines) extends along the drive assembly 62 at the first system end 31 and has a first conveyor end 52 at the start of a travel path 53 that extends in a first direction (arrow A) from the first system end 31 to the second system end 32. Note that the travel path 53 and/or the first direction extend along the shape defined by the frame 15. The second infeed conveyor 51 extends along the travel path 53 to a second conveyor end 55 that is at or near the second system end 32. The second infeed conveyor 51 then transitions from the travel path 53 to a return path 56 that extends from the second system end 32 to the first system end 31. The return path 56 generally extends in a second direction (arrow B) and the return path 46 and the second direction is defined by the frame 15. The second infeed conveyor 51 then transitions from the return path 56 back to the travel path 53 at the first system end 31. The second infeed conveyor 51 is continuously driven along the travel path 53 and the return path 56 and is configured to help convey the dairy containers D to the casing station 90.

The second infeed conveyor 51 can be supported by other guide members 88, and the guide members 88 located at the first system end 31 extend next to the second infeed conveyor 51 and can laterally support the second infeed conveyor 51. The brackets 70 hold the guide members 88 in place such that the second infeed conveyor 51 passes along the guide members 88. Note that several guide members 88 are excluded from FIGS. 3-4 and the brackets 70 for clarity. The guide members 88 can be formed of any suitable material such as plastic or metal. In certain examples, the guide members 88 are formed with anti-friction materials that reduce or eliminate friction between the guide members 88 and the second infeed conveyor 51.

The second infeed conveyor 51 at the first conveyor end 52 is in a first orientation (e.g., vertical orientation), and the orientation of the second infeed conveyor 51 transitions to a second orientation (e.g., diagonal orientation) as the second infeed conveyor 51 is conveyed along the travel path 53. For example, the second infeed conveyor 51 transitions from the first orientation to the second orientation between the first conveyor end 52 and the second conveyor end 55 such that the second infeed conveyor 51 at the second conveyor end 55 is in a second orientation.

For illustrative purposes, FIG. 3 includes a first reference axis 57 that extends parallel with the plane of the surface of the first infeed conveyor 41 at the first conveyor end 52 facing the dairy containers D and illustrates the first orientation of the second infeed conveyor 51 at the first conveyor end 52. FIG. 4 includes a second reference axis 58 that extends parallel with the plane of the surface of the first infeed conveyor 41 at the second conveyor end 45 facing the dairy containers D and illustrates the second orientation of the second infeed conveyor 51 at the first conveyor end 52. FIG. 4 also includes the first reference axis 57 for comparison, and the reference axes 57, 58 define an angle 59 therebetween that corresponds to the degrees in which the second infeed conveyor 51 is reoriented from the first conveyor end 52 to the second conveyor end 55. In certain examples, the angle 59 is in the range of 0.0 degrees to 60.0 degrees. In other examples, the angle 59 is in the range of 0.0 degrees to 90.0 degrees. The shape of the second infeed conveyor 51 can be customized to convey the dairy containers (as well as in other example other products) by placing the brackets 70 in specific locations In other examples, the angle 59 of the second infeed conveyor 52 is equal to the angle 49 of the first infeed conveyor 41.

The change of the second infeed conveyor 51 from the first orientation to the second orientation may be incremental or continuous along the travel path 53 and/or corresponds with the change in orientation of the first infeed conveyor 41. As the infeed conveyor 41, 51 change orientation, the infeed conveyors 41, 51 cradle and support the dairy containers D. The second infeed conveyor 51 and the first infeed conveyor can cooperatively convey the dairy containers D to the second system end 32.

For example, as dairy containers D on the first infeed conveyor 41 at the first conveyor end 42 is changed from the first container orientation (e.g., vertical orientation), the side wall of the dairy containers D engage and/or ride on the second infeed conveyor 51. As such, the second infeed conveyor 51 and the first infeed conveyor 41 together support and/or convey the dairy containers D. By reorienting the dairy containers D as described above, the infeed conveyor system 30 properly orientates the dairy containers D that are received into the casing station 90 without applying large forces (e.g., backpressure upstream on additional dairy containers D) to the diary containers D thereby reducing or eliminating the risk that the infeed conveyor system 30 will damage the diary containers D or cause the diary containers D to leak. The present inventors recognized that conventional caser often reoriented the product containers in a very short distance (e.g., 1.0-2.0 feet) and the backpressure acting on product containers is large over a small number of product containers along the short distance. In contrast, the example casers 10 of the present disclosure reorientate the product containers (e.g., dairy container D) over a longer distance (e.g., 6.0 feet, 11.0 feet) by utilizing of the example brackets 70 and/or the example conveyor systems 30 of the present disclosure thereby reducing and/minimizing the amount of backpressure acting on the product container over the longer distance. Reorientating the dairy containers D according to the present disclosure also minimizes the needed backpressure on the diary containers D for the caser 10 to properly function and thus the caser 10 functions with a low risk of damage to the dairy containers D will increasing the number of dairy containers D that are can loaded into the milk crates M.

Note that the guide members 88 that extend along and support the second infeed conveyor 51 change orientation to match the orientation of the second infeed conveyor 51. Also note that in other examples, the examples infeed conveyor systems 30, the second infeed conveyor 51 is eliminated and the dairy containers D instead slide along guide members 88.

The pair of infeed conveyors 41, 51 advantageously allows for different sized dairy containers (e.g., half gallon dairy containers, gallon dairy containers) to be conveyed by the infeed conveyor system 30 without making substantial and/or time-consuming changes to the infeed conveyor system 30. These advantages are possible due to the open space above the infeed conveyors 41, 51 and the ability of the infeed conveyors 41, 51 to ‘cradle’ differently sized dairy containers D. In contrast, conventional casers may require substantial and time-changes (e.g., removable of rails, increasing the size of conventional conveyors) so that the conventional caser can process and convey different dairy containers.

Referring back to FIGS. 1-2, a rail 66 is connected to the frame 15 and extends along the first infeed conveyor 41 and is configured to prevent the dairy containers D from inadvertently falling off the first infeed conveyor 41. In certain examples, during normal operation of the infeed conveyor system 30 and as the dairy containers D are conveyed from the first system end 31 to the second system end 32, the dairy containers D do not contact the rail 66.

FIG. 1-2 depict example barrier members 67 that extend along the frame 15 and are for guarding the infeed conveyors 41, 51 from contact by arms and/or hands of operator and/or equipment being moved near the caser 10. For example, the barrier members 67 prevent the operator from contacting the infeed conveyors 41, 51 that are moving along the return paths 46, 56. The barrier members 67 can be formed with any suitable material such as plastic or metal. In one examples, the barrier members 67 are PVC pipes. The brackets 70 include one or more holes 77, 84 (FIG. 7) through which the barrier members 67 are routed such that the brackets 70 support and guide the barrier members 67.

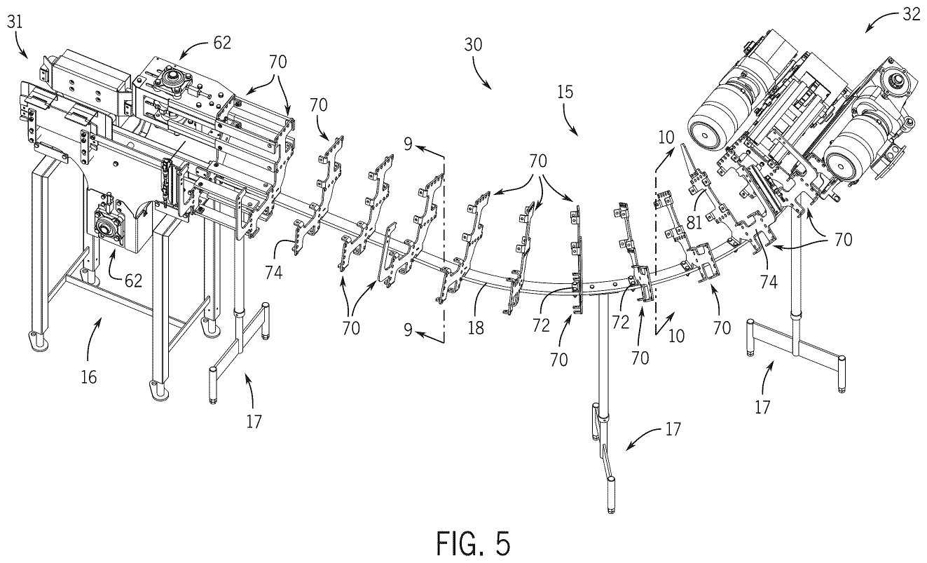

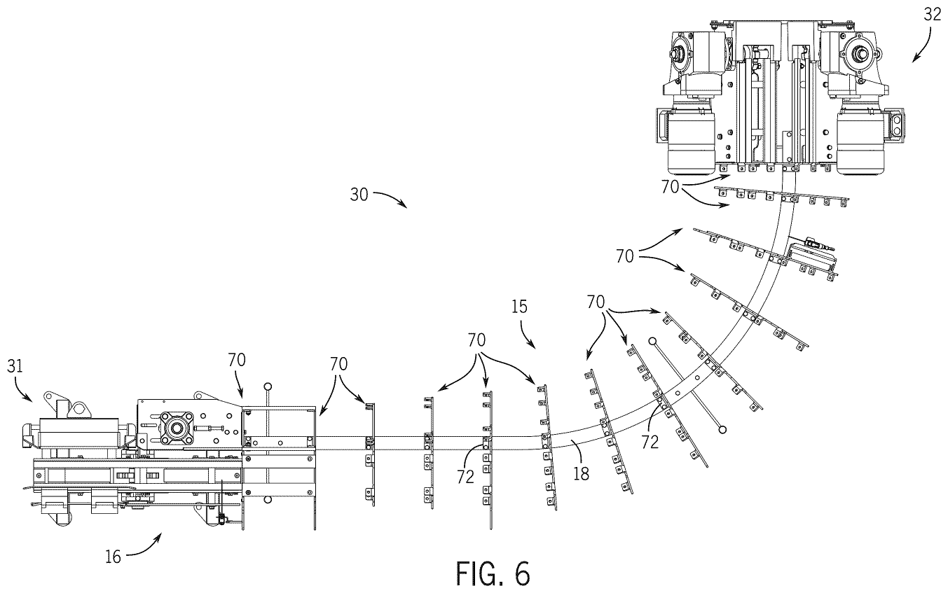

Referring now to FIGS. 5-10, the example frame 15 is depicted in greater detail. The frame 15 includes a platform 16 at the first system end 31 and one or more columns 17 for vertically supporting the other components of the infeed conveyor system 30. The platform 16 and the columns 17 extend vertically from the ground G. The frame 15 also includes a track 18 that extends between and couples the platform 16 and the columns 17 together. The track 18 generally defines the shape of the footprint that the infeed conveyor system 30 occupies. For example, the track 18 depicted in FIGS. 5-6 is curved such that infeed conveyor system 30 is generally “L”-shaped footprint. The track 18 being able to take any shape, allows the infeed conveyor system 30 to be reconfigured into different shapes and orientations. For example, the infeed conveyor system 30 could be constructed to minimize the overall footprint of the caser 10 by locating the first system end 31 close to the casing station 90. Note that in other examples, the track 18 could be straight, and this shape may be utilized when the upstream conveyor 6 (see FIG. 1) is spaced apart from the caser 10. In another example, the shape of track 18 and the infeed conveyor system 30 may generally form a 45.0 degree angle with the casing station 90. In certain examples, the brackets 70 can be rotated a collective 60.0-90.0 degree collectively along the track 18 in order to allow reorientation of the dairy containers D in either a clockwise or counterclockwise direction depending on the specific layout of the example caser 10 and related systems.

Referring specifically to FIG. 7, one or more brackets 70 are coupled to the track 18 and are for supporting the infeed conveyors 41, 51, the rail 66, and/or the barrier members 67. Each bracket 70 includes a mounting flange 72 that is for coupling to the track 18. The mounting flange 72 includes one or more holes (not depicted) through which fasteners (not depicted; e.g., screws, bolts) are received to thereby secure the bracket 70 to the track 18. The brackets 70 can be easily coupled to and repositioned along the track 18 as needed and/or as a different shape of the track 18 is utilized.

The bracket 70 also includes first leg 74 that extends along a first axis 75. The first leg 74 includes one or more support flanges 76 from which the guide members 88 are supported. The first leg 74 includes one or more holes 77 through which the barrier members 67 are routed. A cutout 78 is defined by the first leg 74 and is located between opposing sets of the holes 77 through which the return path 46 of the first infeed conveyor 41 may be routed. The first leg 74 optionally includes a support arm 79 extending transverse from the first leg 74 and for holding the rail 66. Note that in the example depicted in FIGS. 5-6, three of the brackets 70 include the support arm 79.

The bracket 70 also includes second leg 81 that extends along a second axis 82. The second leg 81 includes one or more support flanges 83 from which the guide members 88 are supported. The second leg 81 includes one or more holes 84 through which the additional barrier members 67 are routed. A cutout 85 is defined by the second leg 81 and located between opposing sets of the holes 77 through which the return path 56 of the second infeed conveyor 51 may be routed.

The bracket 70 defines a base axis 86 that extends along the mounting flange 72. The legs 74, 81 are oriented relative to the base axis 86 such that the first axis 75 extends parallel with the base axis 86 and the second axis 82 extends transverse with the base axis 86 (e.g., the second axis 82 extends perpendicular to base axis 86. This example bracket 70 is utilized at or near the first system end 31 and supports the first infeed conveyor 41 in its first orientation and the second infeed conveyor 51 in the first orientation (as described above; see dash-double-dot lines on FIG. 7 that schematically depict the infeed conveyors 41, 51 and the dash-dot lines on FIG. 7 that schematically depicts).

As noted above, the frame 15 includes one or more brackets 70 and the brackets 70 are for supporting the infeed conveyors 41, 51 and the guide members 88 as the orientation of these components change (as described above). The brackets 70 spaced apart along the track 18 have slight differences to facilitate and support the reorientation of the infeed conveyors 41, 51 and the guide members 88. For example, FIG. 8 depicts another example bracket 70 according to the present disclosure that is similar to the bracket 70 depicted in FIG. 7, and the bracket 70 of FIG. 8 includes features similar to bracket 70 depicted in FIG. 7. However, the legs 74, 81 of the bracket 70 in FIG. 8 have a different orientation relative to the orientation of the legs 74, 81 of the bracket 70 depicted in FIG. 7. For example, the first leg 74 is reoriented such that a first angle 21 is defined between the first axis 75 and the base axis 86 and the second leg is reoriented such that a second angle 22 is defined between the second axis 82 and the base axis 86. In one example, the first angle 21 is 18.0 degrees and the second angle 22 is 72.0 degrees.

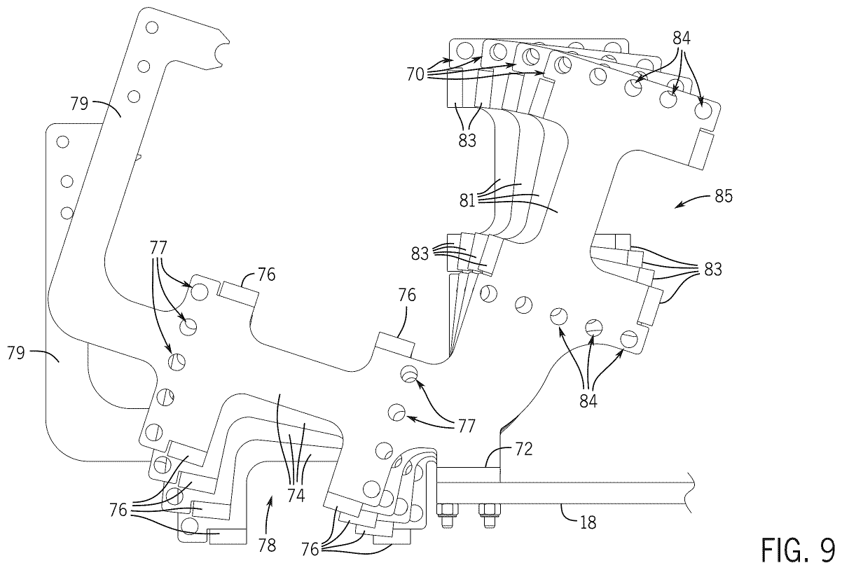

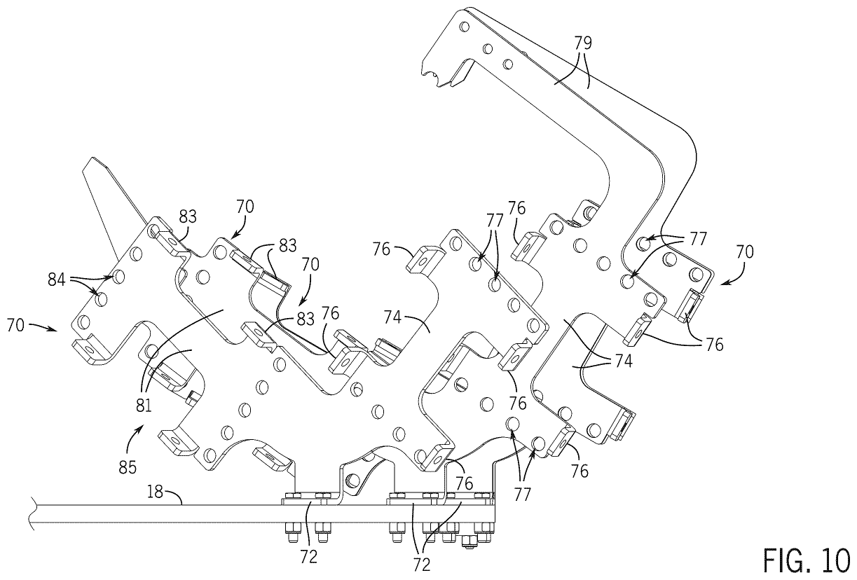

Referring now to FIGS. 9-10, several example brackets 70 are depicted and each bracket 70 has legs 74, 81 with different orientations relative to adjacent brackets 70. In one example, a series of ten brackets 70 have progressively reorientated legs 74, 81 such that the total change in orientation of the axes 75, 82 of the legs 74, 81 relative to the base axis is 60.0 degrees. In this example, each bracket 70 in the series has 6.0 degrees change in the angle 21, 22 relative to the adjacent bracket 70. For instance, the first bracket 70 has a first angle 21 of 6.0 degrees, the second bracket has a first angle 21 of 12.0 degrees, the seventh bracket 70 has a first angle 21 of 42.0 degrees, the ninth bracket 70 has a first angle 21 of 54.0 degrees, and the tenth bracket 70 has a first angle of 60.0 degrees. Note that in certain examples the angle between the first leg 74 and the second leg 81 remains constant as the legs 74, 81 are oriented. In one instance, the legs 74, 81 are perpendicular to each other. In certain examples, the brackets 70 are configured to support a 60.0 degree change in the orientation of the infeed belts 41, 51 over a distance of 6.0 feet along the track 18.

The number of brackets 70 (e.g., four brackets, twenty brackets), the total change in orientation of the legs can vary (e.g., 15.0-90.0 degrees), and/or the degree change between brackets (e.g., 5.0 degrees, 10.0 degrees) can vary.

Referring back to FIG. 1, the dairy containers D are dispensed from the second system end 32 of the infeed conveyor system 30 to the casing station 90. The casing station 90 includes a container inlet 91 that receives the dairy containers D. The dairy containers D are moved in a first direction (arrow D) into the casing station 90 due to the force of the infeed conveyors 41, 51 acting on a stream of dairy containers D at the second system end 33. Optionally, the casing station 90 includes a conveyor system (not depicted) that is configured to convey the dairy containers D in the first direction (arrow D). The casing station 90 further includes a case inlet 92 that is configured to receive milk crates M. As will be described in greater detail herein, the casing station 90 loads the dairy containers D into the milk crates M and the loaded milk crates M′ are dispensed from an outlet 93 onto a table 94 where workers remove the loaded milk crates. In other examples, a conveyor system (not depicted) (which can be separate from or part of the casing station 90) conveys the loaded milk crates M′ away from the casing station 90. The conveyor system can include a belt conveyor and/or a rollers conveyor. In certain examples, the infeed conveyors 41, 51 may continue to operate (as noted above) even if a plurality of diary containers D are collected or ‘staged’ on the infeed conveyor system 30 at the container inlet 91. The collection of the dairy containers D may occur as the casing station 90 operates (e.g., prevent dairy container D from being received and cased faster than the casing station 90 can operate), and as such, forces (e.g., frictional forces) applied to the dairy containers D by the conveyors 41, 51 that are for moving the dairy containers D toward the container inlet 91 cause backpressure on the dairy containers D. The backpressure is distributed through the dairy containers D on the infeed conveyor system 30. The backpressure acting on the dairy containers D processed by the casers 10 of the present disclosure is less than the backpressure applied by conventional casers to product containers.

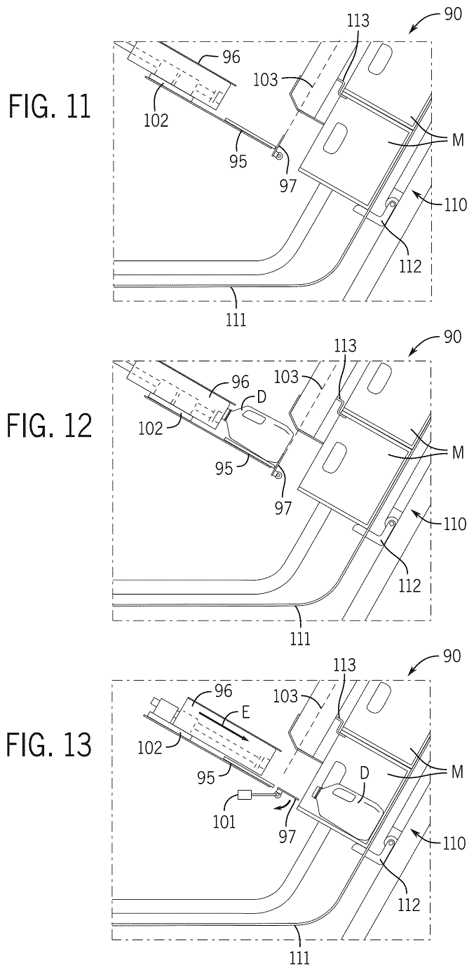

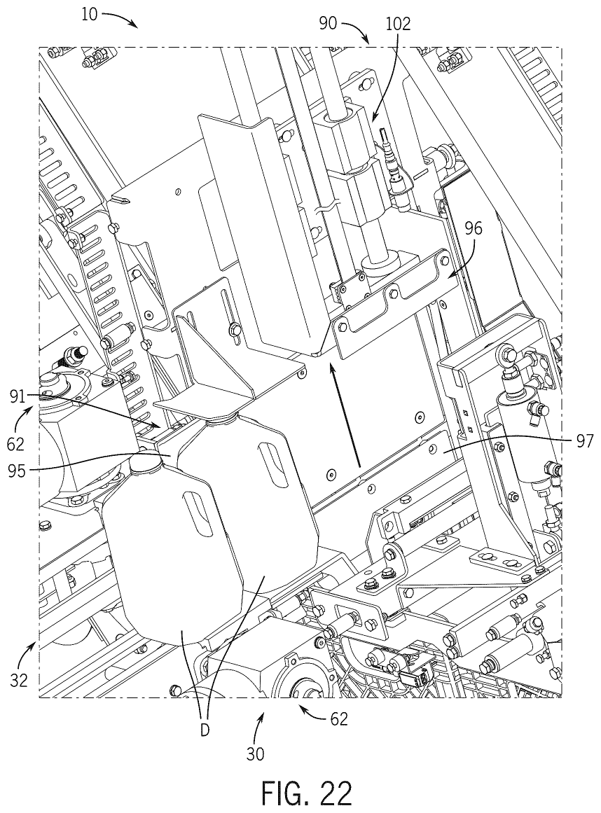

An operation sequence for loading the dairy containers D into the milk crates M is described below with reference to FIGS. 11-22.

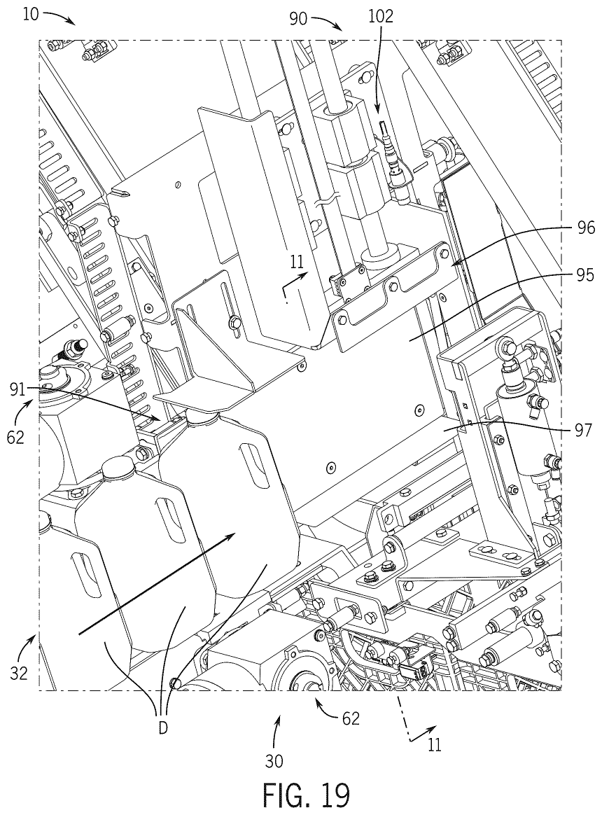

FIG. 11 depicts a schematic view of the interior of the casing station 90 with the dairy containers D not yet received into the container inlet 91 (see also FIG. 19) being conveyed by infeed conveyor system 30 in the first direction (arrow D) toward the container inlet 91. The casing station 90 includes a first support member 95 and a second support member 97 (e.g., plates) onto which the dairy containers D are moved. A finger 112 of a release assembly 110 (described further herein) and a blade stop 113 (e.g., bracket, bent plate) hold the milk crate M such that the dairy containers D can be received into the milk crate M (described further below).

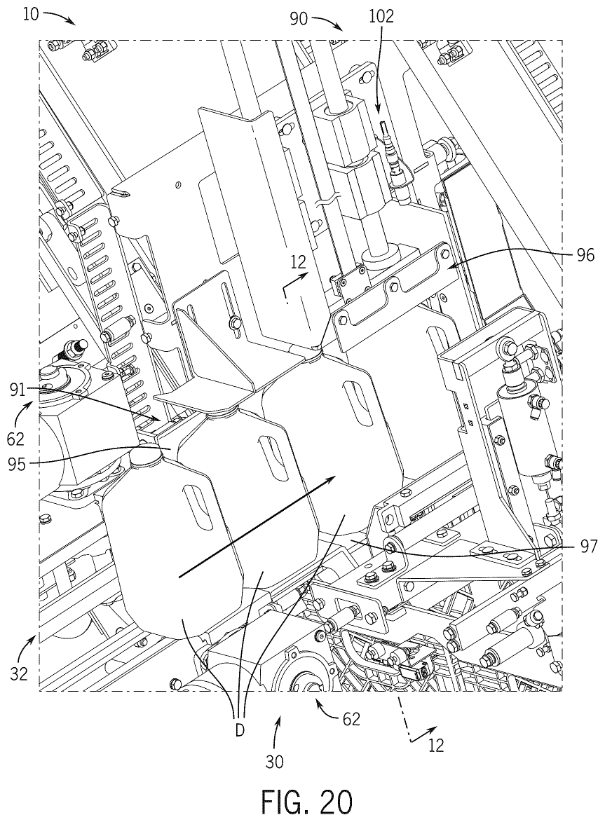

FIG. 12 depicts the dairy containers D moved into casing station 90 and onto a first support member 95 (e.g., plate) (see also FIG. 20). The first support member 95 is oriented in the same orientation as the first infeed conveyor 41 in the second orientation (see FIG. 2) and/or the dairy containers D. As such, the dairy containers D are conveyed and transferred smoothly from the infeed conveyor system 30 onto the first support member 95. In the example depicted in FIG. 20, two dairy containers D are received onto the first support member 95. The casing station 90 includes a pusher 96 for pushing the dairy containers D into the milk crates M (described further herein), and in FIG. 12, the pusher 96 is in a starting or first position. The casing station 90 includes the second support member 97 that is moveable into different positions. The second support member 97 is in a support position in which the second support member 97 supports the dairy container D on the first support member 95. The second support member 97 is oriented in the same orientation as the second infeed conveyor 51 in the second orientation (see FIG. 2). As such, the dairy containers D are conveyed and transferred smoothly from the infeed conveyor system 30 onto the second support member 97. The first support member 95 and the second support member 97 cradle and hold the dairy containers D. Note that the number of dairy containers D moved onto the support members 95, 97 can vary, and in the example depicted in FIG. 20 two dairy conveyers D are moved onto the support members 95, 97.

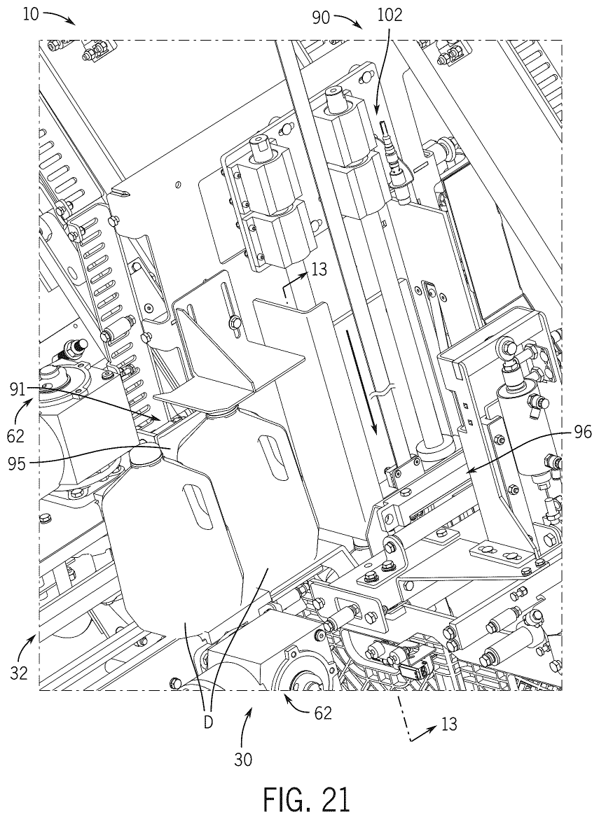

In FIG. 13, the second support member 97 is moved into an open position and the pusher 96 is moved in a first pusher direction (arrow E) into a second position such that the pusher 96 pushes the dairy containers D off the first support member 95 and into the milk crate M (see also FIG. 21). The second support member 97 is moved by an actuator 101 (schematically depicted in FIG. 13) (e.g., linear actuator, gas cylinder, servo motor); and/or the pusher 96 are each moved by actuator 102 (e.g., linear actuator, gas cylinder, servo motor). In the second position, the pusher 96 extends into the area in which the dairy containers D are supported when the second support member 97 is in the first position (FIG. 12). As such, the stroke of the pusher 96 is short thereby increasing the speed of loading the dairy containers D. The pusher 96 can also be moved at high velocities and accelerations which can be adjusted depending the implementation of the caser 10 and the type of dairy containers D. As such, short stroke for higher load rate and/or is customizable per layer of dairy container D for load accuracy. In these examples, the stoke (e.g., the travel distance between the first position and the second position) of the pusher 96 is short and thus the time to make the stroke is minimized when moving the pusher 96. For reference, the dashed line 103 included in FIG. 13 represents the location of the bottom of the first support member 95.

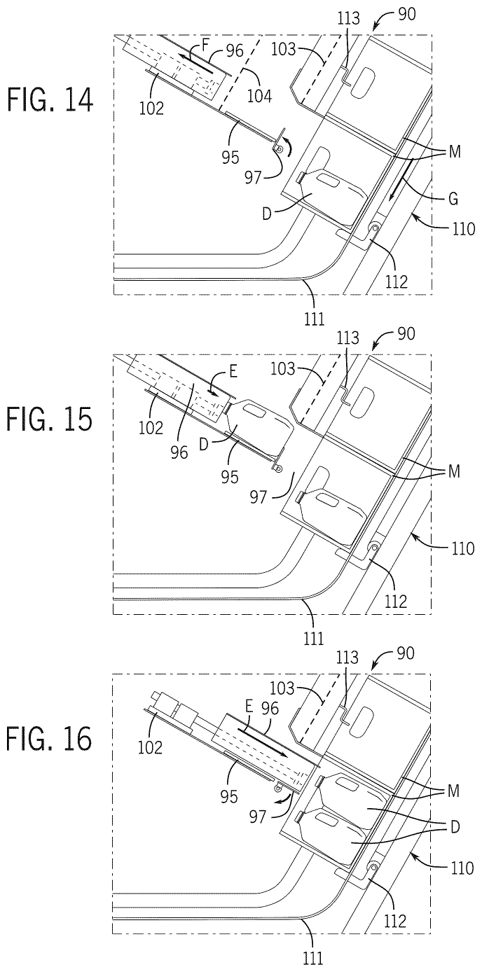

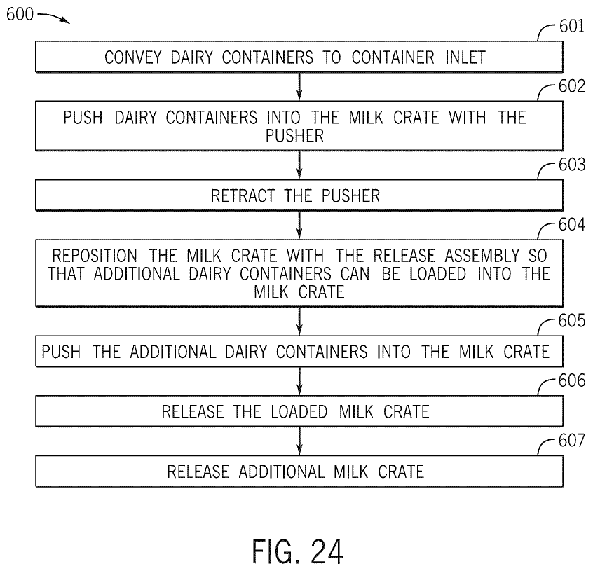

FIG. 14 depicts the pusher 96 moved by the actuator 102 into a retracted position such that the pusher 96 is above the location in which the pusher 96 in the first position (see FIG. 12) (see also FIG. 24). For reference, the dashed line 103 included in FIG. 14 represents the location of the bottom of the pusher 96 in the first support member 95. The pusher 96 extends in the second direction (arrow F) past the first position such that the actuator 102 does not need to reduce the speed of the pusher 96 before the pusher 96 clears the first support member 95. Instead, the pusher 96 is quickly retracted out of the way of additional dairy containers and the first support member 95. The present inventors recognized that ‘over retracting’ the pusher 96 above the first position (dash-dot line 104 on FIG. 14 represents the first position of the pusher 96) advantageously avoids blocking the next dairy container D or set of dairy containers D to be move onto the first support member 95. If the speed of the pusher 96 decreases while located over the first support member 95, the pusher could jam the dairy containers D being moving to the casing station 90. In certain examples, over retracting the pusher 96 advantageously allows the side of the pusher 96 facing and/or contacting the next dairy containers D to move at its top velocity as the pusher 96 clears out of the way from the dairy containers D thereby prevent interference with the dairy containers D and/or tipping from the top of the dairy containers D caused by the pusher 96.

In FIG. 14, the second support member 97 is moved by the actuator 101 into the support position and a release assembly 110 is moved (see arrow G) from a first position in which the release assembly 110 holds the milk crate M such that a first set of dairy containers D is loaded into the milk crate M (see FIG. 13) to a second position below the first position in which the release assembly 110 holds the milk crate M such that a second set of dairy containers D into the mike crate M. Note that the blade stop 113 is moved into a retracted into a second position (not depicted) and the release assembly 110 is moved from the first position to the second position by an actuator (not depicted) or by force of gravity. As such, the milk crates M are moved along a slide member 111 (e.g., rail, plate) that extends between the case inlet 92 to the outlet 93. As such, the milk crate M is in position to receive additional dairy containers D. In certain examples, a toggle stop (not depicted) is located at the case inlet 92 to meter the milk crates M feed along the slide member 111. The toggle stop can manage and/or minimize the backpressure that can act on the milk crates M on the slide member 111. In certain examples, a pin (not depicted) prevent over rotation of the second support member 97 past the second position (see FIG. 13).

Turning now to FIG. 15, additional dairy containers D are conveyed onto the support members 95, 97 and the actuator 102 moves the pusher 96 into the first position. As such, the casing station 90 is ready to move the addition dairy containers D into the milk crate M.

In FIG. 16, the pusher 96 pushes the additional diary containers D into the milk crate M (similar to the description above with respect to FIG. 13).

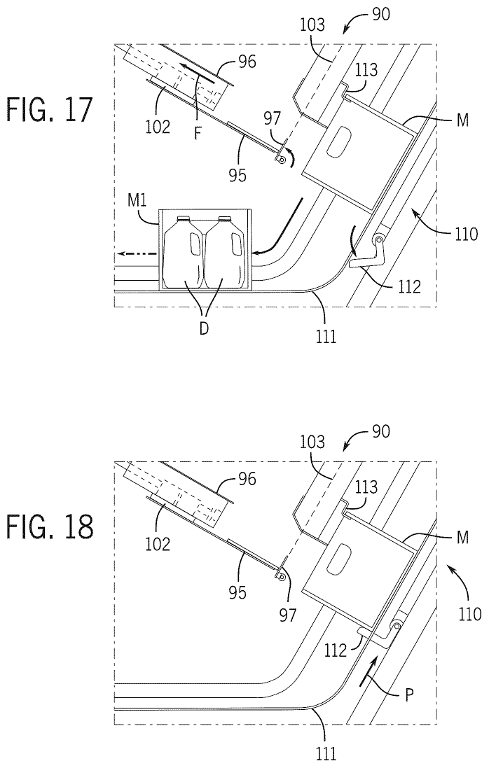

FIG. 17 depicts the pusher moved back into the retracted position as described with respect to FIG. 14. A finger 112 of the release assembly 110 is moved (e.g., by an actuator or by force of gravity) to release the milk crate M loaded with the dairy containers D and the loaded milk crate M is conveyed downstream along the slide member 111 to the outlet 93 (FIG. 1). In addition, the next milk crate M is moved by gravity along the slide member 111 so that the next milk crate M can receive dairy containers D and the blade stop 113 holds the milk crate M in position to receive the dairy containers D.

FIG. 18 depicts the release assembly 110 moved (by an actuator not depicted; see arrow P) to a second position above the first position to thereby engage with an additional milk crate M. The finger 112 is also moved (by an actuator not depicted) into a retaining position to thereby prevent the milk crate M from inadvertently moving along the slide member 111. The blade stop 113 also holds the milk crate M. In certain examples, the finger 112 is moved by an actuator (not depicted; e.g., gas cylinder servo motor). In certain instances, the actuator for moving the finger 112 includes a pilot operated check valve so that partially loaded milk crate M can be held in position while allowing air on actuator to be lowered thereby making reducing the risk of injury to the operator working on the caser 10. The above noted operational sequence can then be repeated to load additional dairy containers D.

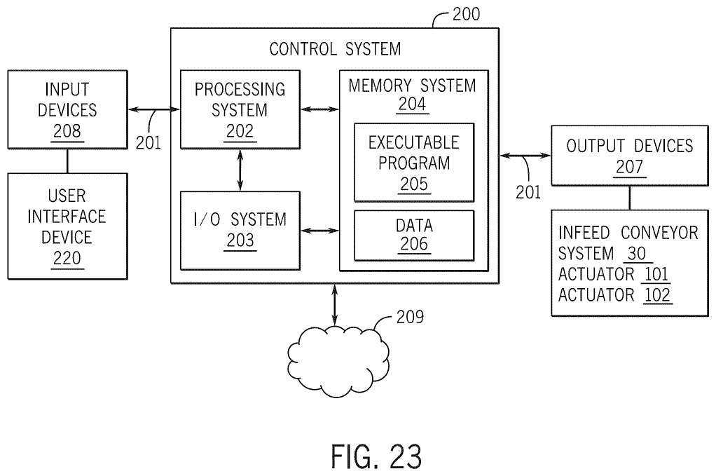

The caser 10 includes or in is communication with a control system 200 such that the operators can control and adjust operation of the caser 10. The operator may provide operator inputs into an user interface device 220 (see FIG. 23) which is connected to the control system 200. FIG. 23 depicts an example control system 100 for control and adjusting operation of the caser 10.

Certain aspects of the present disclosure are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processors or other control devices. The connections between functional and logical block components are merely exemplary, which may be direct or indirect, and may follow alternate pathways.

In certain examples, the control system 200 communicates with each of the one or more components of the caser 10 via a communication link 201, which can be any wired or wireless link. The control system 200 is capable of receiving information and/or controlling one or more operational characteristics of the caser 10 and its various sub-systems by sending and receiving control signals via the communication links 201. In one example, the communication link 201 is a controller area network (CAN) bus; however, other types of links could be used. It will be recognized that the extent of connections and the communication links 201 may in fact be one or more shared connections, or links, among some or all of the components in the caser 10. Moreover, the communication link 201 lines are meant only to demonstrate that the various control elements are capable of communicating with one another, and do not represent actual wiring connections between the various elements, nor do they represent the only paths of communication between the elements. Additionally, the caser 10 may incorporate various types of communication devices and systems, and thus the illustrated communication links 201 may in fact represent various different types of wireless and/or wired data communication systems.

The control system 200 may be a computing system that includes a processing system 202, memory system 204, and input/output (I/O) system 203 for communicating with other devices, such as input devices 208 (e.g., the user interface device 220, encoders, proximity switches, sensors, photo eyes) and output devices 207 (e.g., actuators 101, 102, infeed conveyors 41, 51 of the infeed conveyor system 30), either of which may also or alternatively be stored in a cloud 209. The processing system 202 loads and executes an executable program 205 from the memory system 204, accesses data 206 stored within the memory system 204, and directs the caser 10 to operate as described in further detail below.

The processing system 202 may be implemented as a single microprocessor or other circuitry, or be distributed across multiple processing devices or sub-systems that cooperate to execute the executable program 205 from the memory system 204. Non-limiting examples of the processing system include general purpose central processing units, application specific processors, and logic devices.

The memory system 204 may comprise any storage media readable by the processing system 202 and capable of storing the executable program 205 and/or data 206. The memory system 204 may be implemented as a single storage device, or be distributed across multiple storage devices or sub-systems that cooperate to store computer readable instructions, data structures, program modules, or other data. The memory system 204 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

The control system 200 can be for controlling the actuators 101, 102 and other components noted in the example operational sequence of the caser 10 described above. The control system 200 can also be utilized for the controlling other functions, sequences, and/or methods of the example casers 10 of the present disclosure.

The caser 10 can be operated by the operator in various manners, and an example method of operation is described herein below. Note that certain steps or features of the example method described herein below can be combined with other features, parts of operational sequences example, and/or other example methods.

FIG. 24 depicts an example method 600 for operating the caser 10. The example method 600 may include various steps or features that specifically described hereinbelow. Note that any components noted or described in the example method 600 are depicted in one or more of FIGS. 1-23. Also note the steps noted below can be combined with other steps to form additional example methods.

The method 600 includes, at step 601, conveying with the infeed conveyor system 30 the dairy containers D to the container inlet 91 of the casing station 90. The dairy containers are moved onto the support members 95, 97 below the pusher 96.

At step 602 the pusher 96 is moved from the first position (FIG. 11) toward the second position (FIG. 13) and the second support member 97 is moved from the support position (FIG. 11) to the open position (FIG. 13) such that the pusher 96 pushes and loads the dairy containers D into the milk crate M.

At step 603, the actuator 102 moves the pusher 96 in the second pusher direction (arrow F on FIG. 14) into the retracted position (FIG. 14) such that the pusher 96 is retracted in the second pusher direction past the first position (FIG. 11). In one example the pusher 96 retracts 2.0 inches past the first position. The pusher 96 in the first position is located between the pusher 96 in the second position and the pusher 96 in the retracted position. The second support member 97 is also moved to the support position (FIG. 11).

The release assembly 110, at step 604, is moved from the first position to the second position thereby moving the milk crate M to a position in which it can receive additional dairy containers D (FIG. 15).

At step 605 the second support member 97 is also moved to the retracted position and the pusher 96 pushes the additional dairy containers D into the milk crate M (see FIG. 16).

At 606, the release assembly 110 releases the loaded milk crate M and the blade stop 113 is moved into the second position such that the loaded milk crate M is moved along the slide member 111 (e.g., rail, plate) that extends between the case inlet 92 to the outlet 93.

At step 607 the pusher 96 moved back into the retracted position and the second support member 97 is moved to the support position, blade stop 113 is moved into a first position to thereby hold an additional milk crate M (see FIG. 18), and the release assembly 110 is moved to the second position to thereby engage with the additional milk crate M (see FIG. 18). The blade stop 113 is moved from the first position to the second position such that the additional milk crate M is moved by the release assembly 110.

In certain examples, a caser for packaging a product container in a case includes an infeed conveyor configured to receive the product container at an upstream first conveyor end and convey the product container downstream to a second conveyor end from which the product container is dispensed, the infeed conveyor has a first orientation at a first conveyor end and a second orientation at a second conveyor end, wherein the orientation of the infeed conveyor transitions from the first orientation to the second orientation from the first conveyor end to the second conveyor end such that the infeed conveyor is configured to change orientation of the product container as the product container is conveyed by the infeed conveyor, and a casing station configured to receive the product container from the infeed conveyor and dispense the product container into the case.

Optionally, the infeed conveyor is a continuous belt. Optionally, the first orientation is a horizontal orientation and the second orientation is a diagonal orientation. Optionally, the infeed conveyor is configured to minimize and backpressure acting on the product container and distribute backpressure to additional product containers conveyed by the infeed conveyor. Optionally, the second orientation is 60.0 degrees offset from the first orientation. Optionally, the infeed conveyor is a first infeed conveyor and a second infeed conveyor cooperates with the first infeed conveyor to convey the product containers from the first conveyor end to the second conveyor end and the second infeed conveyor has a first orientation at a first conveyor end and the orientation of the second infeed conveyor transitions from the first orientation to a second orientation at a second conveyor end of the second infeed conveyor such that the second infeed conveyor is configured to cooperate with the first infeed conveyor to thereby change the orientation of the product container. Optionally, the first infeed conveyor and the second infeed conveyor cradle the product container. Optionally, the first infeed conveyor and the second infeed conveyor are continuous belts. Optionally, the first infeed conveyor and the second infeed conveyor extend perpendicular to each other. Optionally, the first orientation of the first infeed conveyor is horizontal orientation and the first orientation of the first infeed conveyor is vertical. Optionally, the second orientation of the first infeed conveyor is a first diagonal orientation and the second orientation of the second infeed conveyor is a second diagonal orientation, and the first diagonal orientation is perpendicular to the second diagonal orientation. Optionally, the infeed conveyor includes a guide member that supports the infeed conveyor, and the orientation of the guide member corresponds to the orientation of the infeed conveyor. Optionally, the infeed conveyor includes a plurality of brackets that support the guide member and the infeed conveyor. Optionally, each bracket has a first leg and a second leg, and the orientation of the first leg and the second leg of one bracket in the plurality of brackets is different than the orientation of the first leg and the second leg of another bracket in the plurality of brackets. Optionally, the casing station configured to receive the case, and the casing station includes a first support member onto which the product container is conveyed and a pusher configured to push the product container into the case. Optionally, the casing station includes a servo motor for moving the pusher. Optionally, the pusher is movable into and between a first position in which the pusher is located above the product container and a second position in which the pusher pushes the product container into the case and when the pusher is moved away from the second position toward the first position, the pusher is first moved in a second pusher direction past the first position before being moved in a first pusher direction back to the first position.

In certain examples, a caser for packaging a product container in a case includes an infeed conveyor system with a first system end configured to receive the product container and a second system end configured to dispense the product container, the infeed conveyor system has a first infeed conveyor configured to support the product container at the first system end and convey the product container downstream toward the second system end and a second infeed conveyor configured to support the product container such that the product container is cradled between the second infeed conveyor and the first infeed conveyor and convey the product container downstream toward the second system end, and a casing station configured to receive the product container from the infeed conveyor system and load the product container into the case.

Optionally, the first infeed conveyor has a first orientation at the first system end and the orientation of the first infeed conveyor transitions from the first orientation to a second orientation in a direction toward the second system end such that that first infeed conveyor is configured to change orientation of the product container and the second infeed conveyor has a first orientation at the first system end and the orientation of the second infeed conveyor transitions from the first orientation to a second orientation in a direction toward the second system end. Optionally, the infeed conveyor is a continuous belt. Optionally, the first orientation of the first infeed conveyor is a horizontal orientation, the first orientation of the second infeed conveyor is a vertical orientation, the second orientation of the first infeed conveyor is a diagonal orientation, and the second orientation of the second infeed conveyor is a diagonal orientation.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the present description, certain terms have been used for brevity, clarity, and understanding. No unnecessary limitations are to be inferred therefrom beyond the requirement of the prior art because such terms are used for descriptive purposes and are intended to be broadly construed. The different apparatuses, systems, and method steps described herein may be used alone or in combination with other apparatuses, systems, and methods. It is to be expected that various equivalents, alternatives, and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A caser for packaging a product container in a case, the caser comprising:
an infeed conveyor configured to receive the product container at an upstream first conveyor end and convey the product container downstream to a second conveyor end from which the product container is dispensed;
wherein the infeed conveyor has a first orientation at a first conveyor end and a second orientation at a second conveyor end, wherein the orientation of the infeed conveyor transitions from the first orientation to the second orientation from the first conveyor end to the second conveyor end such that the infeed conveyor is configured to change orientation of the product container as the product container is conveyed by the infeed conveyor; and
a casing station configured to receive the product container from the infeed conveyor and dispense the product container into the case.

2. The caser according to claim 1, wherein the infeed conveyor is a continuous belt.

3. The caser according to claim 1, wherein the first orientation is a horizontal orientation and the second orientation is a diagonal orientation.

4. The caser according to claim 1, wherein the second orientation is 60.0 degrees offset from the first orientation.

5. The caser according to claim 1, wherein the infeed conveyor is a first infeed conveyor, and further comprising:
a second infeed conveyor that cooperates with the first infeed conveyor to convey the product container from the first conveyor end to the second conveyor end;
wherein the second infeed conveyor has a first orientation at a first conveyor end and the orientation of the second infeed conveyor transitions from the first orientation to a second orientation at a second conveyor end of the second infeed conveyor such that the second infeed conveyor is configured to cooperate with the first infeed conveyor to thereby change the orientation of the product container.

6. The caser according to claim 5, wherein the first infeed conveyor and the second infeed conveyor cradle the product container.

7. The caser according to claim 5, wherein the first infeed conveyor and the second infeed conveyor are continuous belts.

8. The caser according to claim 5, wherein the first infeed conveyor and the second infeed conveyor extend perpendicular to each other.

9. The caser according to claim 5, wherein the first orientation of the first infeed conveyor is horizontal orientation and the first orientation of the first infeed conveyor is vertical.

10. The caser according to claim 9, wherein the second orientation of the first infeed conveyor is a first diagonal orientation and the second orientation of the second infeed conveyor is a second diagonal orientation, and wherein the first diagonal orientation is perpendicular to the second diagonal orientation.

11. The caser according to claim 1, wherein the infeed conveyor is configured to minimize and backpressure acting on the product container and distribute backpressure to additional product container conveyed by the infeed conveyor.

12. The caser according to claim 1, wherein the infeed conveyor includes a guide member that supports the infeed conveyor, and wherein orientation of the guide member corresponds to the orientation of the infeed conveyor.

13. The caser according to claim 12, wherein the infeed conveyor includes a plurality of brackets that support the guide member and the infeed conveyor.

14. The caser according to claim 13, wherein each bracket has a first leg and a second leg, and wherein orientation of the first leg and the second leg of one bracket in the plurality of brackets is different than the orientation of the first leg and the second leg of another bracket in the plurality of brackets.

15. The caser according to claim 1, wherein the casing station configured to receive the case, and wherein the casing station include:
a first support member onto which the product container is conveyed; and
a pusher configured to push the product container into the case.

16. The caser according to claim 15, wherein the casing station includes a servo motor for moving the pusher.

17. The caser according to claim 15, wherein the pusher is movable into and between:
a first position in which the pusher is located above the product container; and
a second position in which the pusher pushes the product container into the case;
wherein when the pusher is moved away from the second position toward the first position, the pusher is first moved in a second pusher direction past the first position before being moved in a first pusher direction back to the first position.

18. A caser for packaging a product container in a case, the caser comprising:
an infeed conveyor system with a first system end configured to receive the product container and a second system end configured to dispense the product container; the infeed conveyor system include:
a first infeed conveyor configured to support the product container at the first system end and convey the product container downstream toward the second system end;
a second infeed conveyor configured to support the product container such that the product container is cradled between the second infeed conveyor and the first infeed conveyor and convey the product container downstream toward the second system end; and
a casing station configured to receive the product container from the infeed conveyor system and load the product container into the case.

19. The caser according to claim 18, wherein the first infeed conveyor has a first orientation at the first system end and the orientation of the first infeed conveyor transitions from the first orientation to a second orientation in a direction toward the second system end such that that first infeed conveyor is configured to change orientation of the product container; and
wherein the second infeed conveyor has a first orientation at the first system end and the orientation of the second infeed conveyor transitions from the first orientation to a second orientation in a direction toward the second system end.

20. The caser according to claim 18, wherein the first infeed conveyor is a continuous belt.

21. The caser according to claim 19, wherein the first orientation of the first infeed conveyor is a horizontal orientation, the first orientation of the second infeed conveyor is a vertical orientation, the second orientation of the first infeed conveyor is a diagonal orientation, and the second orientation of the second infeed conveyor is a diagonal orientation.
